(19) United States
(12) Patent Application Publication
(10) Pub. No.: US 2006/0205600 A1
(43) Pub. Date: Sep. 14, 2006

(54) Herbicidal composition

(75) Inventors: Toshiro Otsubo, Sanda-shi (JP); Atsushi Watanabe, Toyonaka-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 11/078,358

(22) Filed: Mar. 14, 2005

(51) Int. Cl. A01N 35/10; A01N 25/04

(52) U.S. Cl. 504/344; 504/364

(57) ABSTRACT

A herbicidal composition which comprises clethodim, a sulfonate surfactant, a polyoxyalkylene fatty acid ester and an aromatic hydrocarbon gives good stability of the emulsion after it is diluted with water.

### FIELD OF THE INVENTION

The present invention relates to a herbicidal composition.

### BACKGROUND ARTS

Some compositions containing a herbicidal cyclohexanedione compound are known in U.S. Pat. No. 4,626,276, U.S. Pat. No. 4,741,768, U.S. Pat. No. 5,084,087 and U.S. Pat. No. 5,554,576.

### SUMMARY OF THE INVENTION

The present invention provides a herbicidal composition comprising i) clethodim, ii) a sulfonate surfactant, iii) a polyoxyalkylene fatty acid ester and iv) an aromatic hydrocarbon.

According to the present invention, the composition containing clethodim can provide a stable emulsion when it is diluted with hard water as well as normal water.

### DETAILED DESCRIPTION OF THE INVENTION

In the present invention, clethodim is an herbicidal ingredient, and the chemical name of clethodim is (±)-2-[(E)-1-[(E)-3-chloroallyloxyimino]propyl]-5-[2-(ethylthio)propyl]-3-hydroxyclclohex-2-enone of the formula: 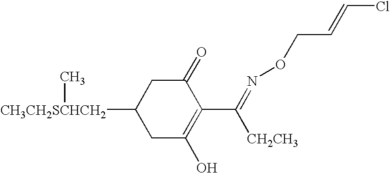
It can be obtained in the market, for example, it is provided by Valent U.S.A. Corporation, Tomen Agro, Inc. or Arvesta Corporation.

The content of clethodim in the herbicidal composition of the present invention is generally 5% to 40% by weight, preferably 10% to 30% by weight.

The sulfonate surfactant means an anionic surfactant having at least one sulfonic acid salt group in the molecule. Examples of the sulfonate surfactant include salts of alkylbenzene sulfonic acid (e.g., (C8-C15 alkyl)benzenesulfonate), salts of alkylnaphthalene sulfonic acid, salts of alkylsulfonic acid, salts of alkyl ether sulfonic acid, salts of fatty alcohol ether sulfonic acid and salts of polyoxyalkylene tristyrylphenyl ether sulfonic acid. Typical examples of the salt are calcium, sodium and potassium salts. Typical examples of the sulfonate are dodecylbenzenesulfonate, diisopropylnaphthalenesulfonate, diisobutylnaphthalenesulfonate, α-olefinsulfonate and dialkylsulfosuccinate. Among them, calcium dodecylbenzenesulfonate, sodium dodecylbenzenesulfonate and potassium dodecylbenzenesulfonate are preferably used.

The content of the sulfonate surfactant in the herbicidal composition of the present invention is generally 0.1% to 10% by weight, preferably 0.1% to 5% by weight.

The polyoxyalkylene fatty acid ester is a nonionic surfactant and it is generally given by the formula:
RCOO(AO)ₙH or RCOO(AO)ₙCOR
wherein R is an alkyl or alkenyl group having 6 to 21 carbon atoms; AO is polyoxyethylene, polyoxypropylene or block copolymer of polyoxyethylene and polyoxypropylene; and n is 2 to 30.

The polyoxyalkylene fatty acid ester is obtained in the market or produced by known methods. For example, polyoxyethylene fatty acid esters can be produced by an addition of ethylene oxide to fatty acid or an esterification of fatty acid with polyethylene glycol.

The polyoxyalkylene fatty acid ester is preferably in the range of from 8 to 16 of HLB, which means Hydrophilic-Lipophilic Balance which is well known in the field of surfactant. Typical examples of the polyoxyalkylene fatty acid ester include polyoxyethylene monooleate, polyoxyethylene dioleate, polyoxyethylene monolaurate, polyoxyethylene dilaurate and polyoxyethylene monostearate.

The content of the polyoxyalkylene fatty acid ester in the herbicidal composition of the present invention is generally 0.1% to 30% by weight, preferably 0.1% to 20% by weight.

The aromatic hydrocarbon is generally a solvent that can dissolve clethodim. Namely, the aromatic hydrocarbon is usually used in the amount that can dissolve the clethodim contained in the herbicidal composition.

Examples of the aromatic hydrocarbon include xylene, phenylxylylethane, Hisol SAS-296 (a mixture of 1-phenyl-1-xylylethane and 1-phenyl-1-ethylphenylethane, commercial name of Nippon Petroleum Company), Cactus Solvent HP-DMN (containing 80% of dimethylnaphthalene, commercial name of Nikko Petrochemical Company), Cactus Solvent P-100 (alkylbenzene having 9 to 10 of carbon number, commercial name of Nikko Petrochemical Company), Aromatic 150 (aromatic hydrocarbon, commercial name of ExxonMobil Chemical) and Aromatic 200 (aromatic hydrocarbon, commercial name of ExxonMobil Chemical).

The content of the aromatic hydrocarbon in the herbicidal composition of the present invention is generally 10% to 89.8% by weight.

Further, the herbicidal composition optionally comprises the other solvent, auxiliaries such as esters of fatty acids, antioxidant, fungicide, perfume, dyestuff, and so on.

The esters of fatty acid are generally can work as enhancer of bioefficacy. The formula of esters of fatty acid is R¹COOR²; wherein R¹ is an alkyl group having 7 to 21 carbon atoms or an alkenyl group having 7 to 21 carbon atoms, and R² is an alkyl group having 1 to 8 carbon atoms. Examples of the group given by the formula R¹CO include palmitoyl, myristoyl, stearoyl, lauroyl and oleoyl. Examples of R² are methyl, ethyl, isopropyl, butyl, isobutyl and octyl. Typical examples are methyl oleate, methyl palmitate, methyl laurate, isopropyl myristate, isopropyl palmitate, octyl laurate, octyl palmitate and butyl stearate.

When the ester of fatty acid is used, the content of the ester of fatty acid in the herbicidal composition is generally 0.1% to 79.8% by weight, preferably 10% to 50% by weight. In addition, when the ester of fatty acid is used, the content of the aromatic hydrocarbon in the herbicidal composition of the present invention is preferably 10% to 60% by weight.

Preferably, propyl gallate is used for antioxidant; the content of the propyl gallate in the herbicidal composition is generally 0.01% to 10% by weight, preferably 0.1% to 3% by weight.

The herbicidal composition of the present invention can be prepared by mixing i) clethodim, ii) a sulfonate surfactant, iii) a polyoxyalkylene fatty acid ester and iv) an aromatic hydrocarbon, and optionally the other solvent, auxiliaries and so on.

The herbicidal composition of the present invention is utilized as an emulsifiable concentrate in general, namely it is diluted with water to give an emulsion and applied to weeds, especially graminaceous weeds such as Agropyron tsukushiense, barnyardgrass (Echinochloa crus-galli), green foxtail (Setaria viridis), giant foxtail (Setaria faheri), large crabgrass (Digitaria sanguinalis), annual bluegrass (Poa annua), blackgrass (Alopecurus myosuroides), oats (Avena sativa), wild oats (Avena fatua), johnsongrass (Sorghum halepense), quackgrass (Agropyron repens), downy brome (Bromus tectorum) and bermudagrass (Cynodon dactylon) in broad-leaf crop (e.g. soybean, cotton, sugarbeet, peanut) fields. The application dosage is generally 10 g to 1000 g per hectare in the amount of clethodim, although it may vary with the kinds of objective weeds, weather conditions and so on. The dilution of the herbicidal composition can also be used for aerial application by helicopter, plane or radio-controlled helicopter. The herbicidal composition of the present invention may be diluted with water containing a spreading agent. Examples of the spreading agent include Agridex (commercial name of Helena Chemical Corporation), Dynamic (commercial name of Helena Chemical Corporation), Induce (commercial name of Helena Chemical Corporation) and Silwet L-77 (manufactured by Nihon Unicar).

In the present invention, an addition of another nonionic surfactant may increase a stability of the herbicidal composition. The nonionic surfactant is preferably selected from the group consisting of polyoxyalkylene polyaryl ethers, block copolymers of ethylene oxide and propylene oxide, polyoxyalkylene alkylphenyl ethers, polyoxyalkylene fatty alcohol ethers, polyoxyethylene alkanol amides, polyoxyethylene sorbitan fatty acid esters and polyoxyethylene plant oils.

The polyoxyalkylene polyaryl ether means a nonionic surfactant having two or more aromatic ring, wherein at least one aromatic ring has a polyoxyalkylene group, and an ether structure in the molecule. Typical examples of the polyoxyalkylene polyaryl ether include polyoxyalkylene styryl phenyl ether, polyoxyalkylene styryl phenylphenyl ether, polyoxyalkylene benzyl phenyl ether, polyoxyalkylene benzyl phenylphenyl ether and polyoxyalkylene bisphenyl ether. The polyoxyalkylene part is generally polyoxyethylene, polyoxypropylene or block copolymer of polyoxyethlene and polyoxypropylene. Typical examples are polyoxyalkylene tristyryl phenyl ether (e.g., polyoxyethylene tristyryl phenyl ether, polyoxyethylene polyoxypropylene tristyryl phenyl ether) and polyoxyalkylene distyryl phenyl ether (e.g., polyoxyethylene distyryl phenyl ether).

The block copolymer of ethylene oxide (EO) and propylene oxide (PO) is also called polyoxylethylene polyoxypropylene block copolymer. Examples of the block copolymer of ethylene oxide and propylene oxide are (PO)ₓ—(EO)_{y}, (EO)ₓ—(PO)_{y}, (PO)ₓ—(EO)_{y}—(PO)_{z} and (EO)ₓ—(PO)_{y}-(EO)_{z}. Among them, (PO)ₓ—(EO)_{y}—(PO)_{z}, namely 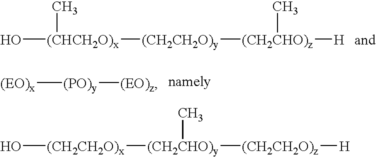
are preferably used.

The polyoxyalkylene alkylphenyl ether is also known as polyoxyalkylene alkyl phenol and it means a nonionic surfactant that is polyoxyalkylated alkylphenol. It is typically given by the formula: R—C₆H₄—O—(AO)ₙH, wherein R is an alkyl, (AO)ₙ is polyoxyethylene, polyoxypropylene or polyoxyethylene polyoxypropylene block copolymer and n is 2 to 50. Typical examples of the polyoxyalkylene alkylphenyl ether include polyoxyethylene nonylphenyl ether and polyoxyethylene octylphenyl ether.

The polyoxyalkylene fatty alcohol ether means a nonionic surfactant that is polyoxyalkylated fatty alcohol. It is also known as polyoxyalkylene alkyl ether. It is typically given by the formula: R—O—(AO)ₘH, wherein R is a higher alkyl optionally containing one or more carbon-carbon double bonds therein, in other words, R may be alkenyl, (AO)ₘ is polyoxyethylene, polyoxypropylene or polyoxyethylene polyoxypropylene block copolymer and m is 2 to 20. Typical examples of the polyoxyalkylene alkyl ether include polyoxyethylene lauryl ether, polyoxyethylene octyl ether, polyoxyethylene myristyl ether, polyoxyethylene stearyl ether and polyoxyethylene oleyl ether. It is prepared by addition of alkylene oxide (e.g., ethylene oxide, propylene oxide) of fatty alcohol, namely C10-C22 aliphatic alcohol.

The polyoxyalkylene alkanolamide is a polyoxyalkylenated fatty acid amide in general. It is typically given by the formula: RCONH(AO)ₙH or RCON[(AO)ₙH]₂ wherein R is an alkyl group having 6 to 21 carbon atoms, (AO)ₙ is polyoxyethylene, polyoxypropylene or polyoxyethylene polyoxypropylene block copolymer and n is 2 to 30. The RCONH(AO)ₙH type is preferably used. Examples of the polyoxyalkylene alkanolamide surfactant include polyoxyethylene lauramide, polyoxyethylene stearamide, polyoxyethylene cocamide, polyoxypropylene cocamide, polypropylene glycol 2-hydroxyethyl isostearamide and polypropylene glycol 2-hydroxyethyl cocamide.

The polyoxyethylene sorbitan fatty acid ester is an addition product of ethylene oxide to sorbitan fatty acid ester, wherein the fatty acid is generally saturated or unsaturated C8-C22 aliphatic acid. Examples of the polyoxyethylene sorbitan fatty acid ester include polyoxyethylene sorbitan monooleate, polyoxyethylene sorbitan monostearate, polyoxyethylene sorbitan monomyristate and polyoxyethylene sorbitan monotallate.

The polyoxyethylene plant oil is an addition product of ethylene oxide to plant oil. Typical example is polyoxyethylene castor oil.

When the nonionic surfactant is used, the herbicidal composition of the present invention generally comprises 5% to 40% by weight of clethodim, 0.1% to 10% by weight of a sulfonate surfactant, 10% to 50% by weight of a polyoxyalkylene fatty acid ester, 0.1% to 30% of another nonionic surfactant and 10 to 84.8% by weight of an aromatic hydrocarbon, preferably comprises 10% to 30% by weight of clethodim, 0.1% to 5% by weight of a sulfonate surfactant, 20% to 50% by weight of a polyoxyalkylene fatty acid ester, 0.1% to 20% of another nonionic surfactant and 10 to 60% by weight of an aromatic hydrocarbon.

### EXAMPLES

Hereinafter, the present invention is explained in more detail referring to examples, but the present invention should not be limited in the following examples.

### Example 1

The following ingredients were thoroughly mixed to give a herbicidal composition of the present invention.

| | |
|---|---|
| Clethodim (purity: 93%) | 13.5 wt % |
| Calcium dodecylbenzenesulfonate (60% calcium | 3.4 wt % |
| dodecylbenzenesulfonate, Ninate 401A supplied by Stepan) | |
| Polyoxyethylene monolaurate (HLB 14.8, molecular weight | 2.0 wt % |
| of polyethylene 600, Agnique PEG600ML supplied by | |
| Cognis) | |
| Aromatic 150 (aromatic hydrocarbon, commercial name | 81.1 wt % |
| of ExxonMobil Chemical) | |

### Example 2

The following ingredients were thoroughly mixed to give a herbicidal composition of the present invention.

| | |
|---|---|
| Clethodim (purity: 93%) | 13.5 wt % |
| Calcium dodecylbenzenesulfonate (60% calcium | 3.4 wt % |
| dodecylbenzenesulfonate, Ninate 401A supplied by Stepan) | |
| Polyoxyethylene monolaurte (HLB 14.8, molecular weight | 2.0 wt % |
| of polyethylene 600, Agnique PEG600ML supplied | |
| by Cognis) | |
| Methyl oleate (Agnique ME 181-U supplied by Cognis) | 40.0 wt % |
| Aromatic 150 (aromatic hydrocarbon, commercial name | 41.1 wt % |
| of ExxonMobil Chemical) | |

### Example 3

The following ingredients were thoroughly mixed to give a herbicidal composition of the present invention.

| | |
|---|---|
| Clethodim (purity: 93%) | 13.5 wt % |
| Calcium dodecylbenzenesulfonate (60% calcium | 1.7 wt % |
| dodecylbenzenesulfonate, Ninate 401A supplied by Stepan) | |
| Polyoxyethylene monooleate (HLB 8.3, molecular weight | 40.0 wt % |
| of polyethylene 200, Emerest 2624 supplied | |
| by Cognis) | |
| Polyoxyethylene polyoxypropylene tristyryl phenyl ether | 1.0 wt % |
| (HLB 13.5, Soprophor 796P supplied by Rhodia) | |
| Aromatic 150 (aromatic hydrocarbon, commercial name | 43.8 wt % |
| of ExxonMobil Chemical) | |

### Example 4

The following ingredients were thoroughly mixed to give a herbicidal composition of the present invention.

| | |
|---|---|
| Clethodim (purity: 93%) | 13.5 wt % |
| Calcium dodecylbenzenesulfonate (60% calcium | 1.7 wt % |
| dodecylbenzenesulfonate, Ninate 401A supplied by Stepan) | |
| Polyoxyethylene monooleate (HLB 11.8, molecular weight | 40.0 wt % |
| of polyethylene 400, Agnique PEG400MO supplied | |
| by Cognis) | |
| Polyoxyethylene polyoxypropylene tristyryl phenyl ether | 1.0 wt % |
| (HLB 13.5, Soprophor 796P supplied by Rhodia) | |
| Aromatic 150 (aromatic hydrocarbon, commercial name of | 43.8 wt % |
| ExxonMobil Chemical) | |

### Example 5

The following ingredients were thoroughly mixed to give a herbicidal composition of the present invention.

| | |
|---|---|
| Clethodim (purity: 93%) | 13.5 wt % |
| Calcium dodecylbenzenesulfonate (60% calcium | 1.7 wt % |
| dodecylbenzenesulfonate, Ninate 401A supplied by Stepan) | |
| Polyoxyethylene monolaurate (HLB 9.3, molecular weight | 40.0 wt % |
| of polyethylene 200, Emerest 2620 supplied | |
| by Cognis) | |
| Polyoxyethylene polyoxypropylene tristyryl phenyl ether | 1.0 wt % |
| (HLB 13.5, Soprophor 796P supplied by Rhodia) | |
| Aromatic 150 (aromatic hydrocarbon, commercial name | 43.8 wt % |
| of ExxonMobil Chemical) | |

### Example 6

The following ingredients were thoroughly mixed to give a herbicidal composition of the present invention.

| | |
|---|---|
| Clethodim (purity: 93%) | 13.5 wt % |
| Calcium dodecylbenzenesulfonate (60% calcium | 1.7 wt % |
| dodecylbenzenesulfonate, Ninate 401A supplied by Stepan) | |
| Polyoxyethylene monooleate (HLB 13.6, molecular weight | 40.0 wt % |
| of polyethylene 600, Agnique 600ML supplied | |
| by Cognis) | |
| Polyoxyethylene polyoxypropylene tristyryl phenyl ether | 1.0 wt % |
| (HLB 13.5, Soprophor 796P supplied by Rhodia) | |
| Aromatic 150 (aromatic hydrocarbon, commercial name | 43.8 wt % |
| of ExxonMobil Chemical) | |

### Test Example 1

342 ppm hard water (obtained by dissolving 3.04 g of anhydrous calcium chloride and 0.139 g of magnesium chloride hexahydrate in distilled water and making up to 1 litter) was charged in a 95 ml-cylinder with lid, and keep at room temperature. Then 5 ml of each of the compositions obtained in Examples 1 to 5 was added. The cylinders were inverted 10 times in 20 seconds. After keeping the cylinders for two hours at room temperature, the separation of the top layer was observed as emulsion stability.

| Example No. | Emulsion stability |
|---|---|
| 1 | excellent |
| 2 | excellent |

### Test Example 2

Each of the tested compositions was diluted with water and applied to weeds (post-emergency field test). The weed sizes are as follows: Barnyardgrass (6 inches), Seedling Johnsongrass (4-6 inches), Broadleaf Signalgrass (3-4 inches) and Giant Foxtail (4-5 inches). The application rate was 34 g per hectare in the amount of clethodim and the splayed volume was 188 litters per hectare. After 3 days, the second application was conducted. Observation was conducted after 21 days after first application. Evaluation of weed control was used 0-10 scale. (0: no damage, 10: complete kill, 8, 9 and 10 are usually practically acceptable and less than 6 is insufficient.) The evaluation number of weed control described below is the average over 4 weeds: Barnyardgrass, Seedling Johnsongrass, Broadleaf Signalgrass and Giant Foxtail.

| Example No. | Weed control |
|---|---|
| 3 | 8 |
| 4 | 9 |
| 5 | 9 |
| 6 | 9 |
| No application | 0 |

1. A herbicidal composition which comprises clethodim, a sulfonate surfactant, a polyoxyalkylene fatty acid ester and an aromatic hydrocarbon.

2. The herbicidal composition according to claim 1, which comprises 5% to 40% by weight of clethodim, 0.1% to 10% by weight of a sulfonate surfactant, 0.1% to 30% by weight of a polyoxyalkylene fatty acid ester and 10 to 89.8% by weight of an aromatic hydrocarbon.

3. The herbicidal composition according to claim 1, which comprises 10% to 30% by weight of clethodim, 0.1% to 5% by weight of a sulfonate surfactant, 0.1% to 20% by weight of a polyoxyalkylene fatty acid ester and 10 to 89.8% by weight of an aromatic hydrocarbon.

4. The herbicidal composition according to claim 1, which comprises clethodim, a sulfonate surfactant, a polyoxyalkylene fatty acid ester and an aromatic hydrocarbon and an ester of fatty acid.

5. The herbicidal composition according to claim 4, which comprises 5% to 40% by weight of clethodim, 0.1% to 10% by weight of a sulfonate surfactant, 0.1% to 30% by weight of a polyoxyalkylene fatty acid ester, 10% to 89.8% by weight of an aromatic hydrocarbon and 0.1% to 79.8% by weight of an ester of fatty acid.

6. The herbicidal composition according to claim 4, which comprises 10% to 30% by weight of clethodim, 0.1% to 5% by weight of a sulfonate surfactant, 0.1% to 20% by weight of a polyoxyalkylene fatty acid ester, 10% to 60% by weight of an aromatic hydrocarbon and 10% to 50% by weight of an ester of fatty acid.

7. The herbicidal composition according to claim 6, wherein the ester of fatty acid is methyl oleate.

8. The herbicidal composition according to claim 1, wherein the polyoxyalkylene fatty acid ester is selected from the group consisting of polyoxyethylene monooleate, polyoxyethylene dioleate, polyoxyethylene monolaurate, polyoxyethylene dilaurate and polyoxyethylene monostearate.

9. The herbicidal composition according to claim 1, wherein the sulfonate surfactant is a salt of dodecylbenzenesulfonic acid.

10. The herbicidal composition according to claim 1, which comprises clethodim, a sulfonate surfactant, a polyoxyalkylene fatty acid ester, another nonionic surfactant and an aromatic hydrocarbon.

11. The herbicidal composition according to claim 10, wherein the other nonionic surfactant is at least one selected from the group consisting of polyoxyalkylene polyaryl ethers, block copolymers of ethylene oxide and propylene oxide, polyoxyalkylene alkylphenyl ethers, polyoxyalkylene fatty alcohol ethers, polyoxyethylene alkanol amides, polyoxyethylene sorbitan fatty acid esters and polyoxyethylene plant oils.

12. The herbicidal composition according to claim 10, wherein the other nonionic surfactant is a polyoxyalkylene polyaryl ether.

13. The herbicidal composition according to claim 10, which comprises 5% to 40% by weight of clethodim, 0.1% to 10% by weight of a sulfonate surfactant, 10% to 50% by weight of a polyoxyalkylene fatty acid ester, 0.1% to 30% of the other nonionic surfactant and 10 to 84.8% by weight of an aromatic hydrocarbon.

14. The herbicidal composition according to claim 10, which comprises 10% to 30% by weight of clethodim, 0.1% to 5% by weight of a sulfonate surfactant, 20% to 50% by weight of a polyoxyalkylene fatty acid ester, 0.1% to 20% of another nonionic surfactant and 10 to 60% by weight of an aromatic hydrocarbon.
